(19) United States
(12) Patent Application Publication
(10) Pub. No.: US 2021/0245307 A1
(43) Pub. Date: Aug. 12, 2021

(54) ASSEMBLY AND WELDING UNIT FOR MANUFACTURING PIPES

(71) Applicant: AKTSIONERNOE OBSHCHESTVO "CHELYABINSKIY TRUBOPROKATNYI ZAVOD" (PAO "CHTPZ"), Chelyabinsk (RU)

(72) Inventors: Aleksandr Igorevich ROMANTSOV, Chelyabinsk (RU); Mikhail Aleksandrovich FEDOROV, Chelyabinsk (RU); Anton Aleksandrovich CHERNYAEV, Trekhgornyi (RU); Aleksandr Olegovich KOTLOV, Emanzhelinsk (RU)

(21) Appl. No.: 16/478,475

(22) PCT Filed: Dec. 5, 2017
(86) PCT No.: PCT/RU2017/000894

§ 371 Date: Jul. 16, 2019

(30) Foreign Application Priority Data
Jan. 16, 2017 (RU) 2017101392

(51) Int. Cl. B23K 37/02; B21C 37/15; B23K 31/02; B23K 37/053; B23K 31/10; B23K 26/282

(52) U.S. Cl. CPC B23K 37/0282; B21C 37/154; B23K 31/027; B23K 2101/06; B23K 31/10; B23K 26/282; B23K 37/0538

(57) ABSTRACT

The assembly and welding mill for production of pipes includes a tubular billet feed device with a roller table having a longitudinal axis and passing through the assembly and welding stand with radial hold-down roller beams intended for reduction of a tubular billet that travels along the roller table and a longitudinally oriented guide knife, a carriage with rollers enabling rotation of the rollers on the inner surface of the tubular billet being moved through the assembly and welding stand. On the supporting elements of assembly and welding stand there is a laser welding head or a laser-arc hybrid welding head that can travel in transverse and vertical directions and around longitudinal axis. The carriage is rigidly connected with the supporting elements of the assembly and welding stand through a vertically oriented and longitudinally directed connecting knife. The guide knife is intended for tubular billet positioning through opening of edges at 12 o'clock position and is mounted on the supporting elements of the assembly and welding stand configured to enable vertical travel and fixation. On the carriage, there is a hold-down roller facing upwards that can travel in vertical direction to act on the edges of tubular billet from the inner side, while one of the roller beams is installed vertically that can act on the tubular billet edges from the outer side. Technical result: application of a root weld with laser technologies with guaranteed alignment of tubular billet edges regardless of size.

The invention relates to production of large diameter pipes, in particular, to pipe welding equipment using laser and laser-arc hybrid welding.

Due to the use of laser and laser-arc hybrid welding techniques, new equipment for production of pipes ensuring compliance with high requirements for weld quality becomes required.

A technical solution is known that describes a mill for assembly and welding of straight-seam large diameter pipes with finite length, representing a welding stand with replaceable mandrels for different sizes of tubular billets and equipped with an internal mandrel rigidly connected to stand structural elements, using a knife passing between open edges of a tubular billet, which was not closed yet, and equipped with rollers that rotate along the inner surface of the tubular billet as it is passing through the stand (the closest equivalent is described in utility model patent RU No. 129853).

In the known mill, mandrels are made replaceable to suit different pipe sizes.

Thus, when this technical solution is used, a technical problem occurs of mill conversion from one pipe size to another, which results in time losses. This can additionally cause a need in extra storage areas for mandrels.

Another technical problem is that edges of tubular billets cannot be aligned for weld application, which is the main factor of weld quality.

It should be also noted that the known mill has still not been adapted for weld application on the outer side of tubular billet, using laser technologies.

The technical problem is associated with development of an assembly and welding mill for production of pipes, such mill ensuring root weld application using laser technologies with achievement of technical result, i.e. possibility of weld application to pipes of different sizes during welding at outer side with guaranteed alignment of tubular billet edges.

The proposed assembly and welding mill for production of pipes includes a tubular billet feed device with a roller table having a longitudinal axis and passing through the assembly and welding stand with radial hold-down roller beams intended for reduction of a tubular billet that travels along the roller table, as well as a longitudinally oriented guide knife, a carriage with rollers enabling rotation of the rollers on the inner surface of the tubular billet being moved through the assembly and welding stand, while on the supporting elements of the assembly and welding stand there is a laser welding head or a laser-arc hybrid welding head that can travel in transverse and vertical directions and around the longitudinal axis; the carriage is rigidly connected with the supporting elements of the assembly and welding stand through a vertically oriented and longitudinally directed connecting knife; the guide knife is intended for tubular billet positioning through opening of edges at 12 o'clock position and is mounted on the supporting elements of the assembly and welding stand configured to enable vertical travel and fixation; on the carriage, there is a hold-down roller facing upwards that can travel in vertical direction to act on the edges of tubular billet from the inner side, while one of the roller beams is installed vertically and can act on the tubular billet edges from the outer side.

The solution of this technical problem is associated with availability of new devices comprised in the assembly and welding stand, i.e. the laser welding head or the laser-arc hybrid welding head, and mounted on supporting elements of the assembly and welding stand configured to travel vertically and horizontally in the transverse direction relative to specified longitudinal axis of the assembly and welding stand and to travel in an angular direction (around the longitudinal axis).

The roller table passing through the assembly and welding stand enables reduction of the tubular billet as it continuously passes with its edges being in the specified position at 12 o'clock.

The function of the hold-down roller located inside the tubular billet and the upright roller beam enables alignment of the tubular billet edges relative to each other before welding. Thus, tubular billet edges are aligned at the top and bottom sides.

As the edges are held down with the roller beam from outside and with the thrust roller and simultaneously with roller beams radially across the whole section of the tubular billet, this ensures accuracy of assembly of edge joints and enables continuous welding of the root weld.

The abovementioned implies that the proposed mil is universal, i.e. it can be used for welding on outer side of tubular billets of different sizes, as it is possible to adjust the height of the hold-down roller all the way to the inner surface of the tubular billet.

Therefore, this invention contains functionally interrelated and structurally uniform attributes enabling the use of a welding head installed outside of a tubular billet regardless of its size.

This invention is explained with drawings:

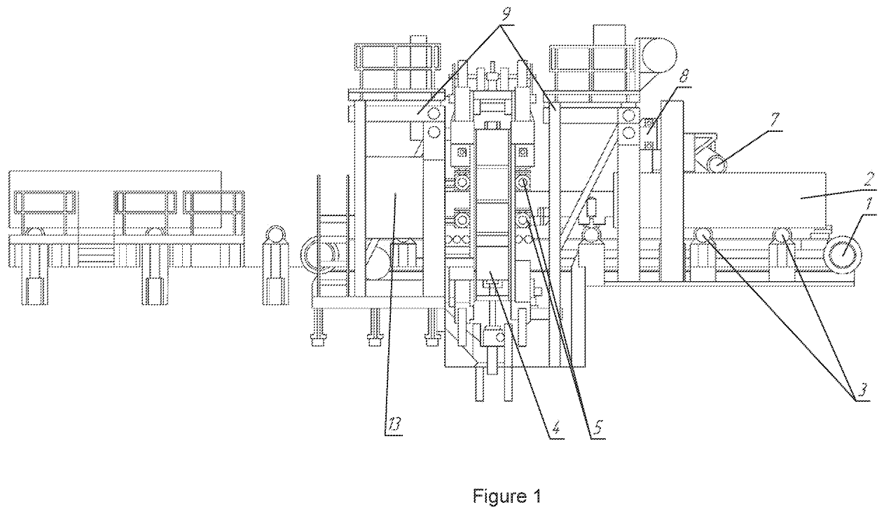

FIG. 1—general view (side view);

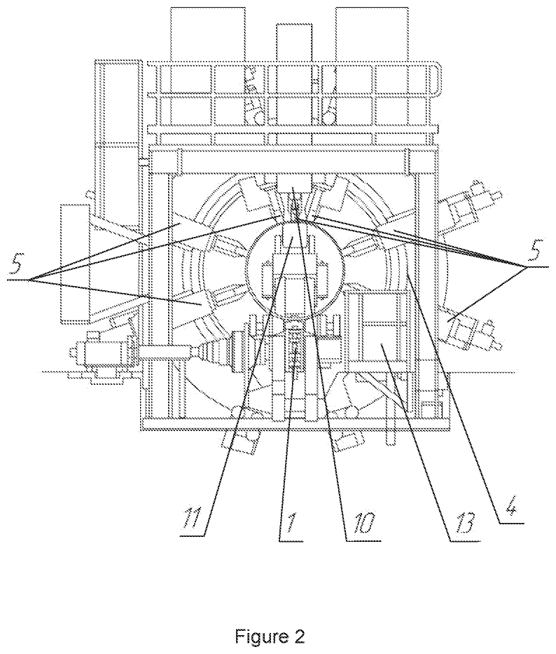

FIG. 2—general view (left view);

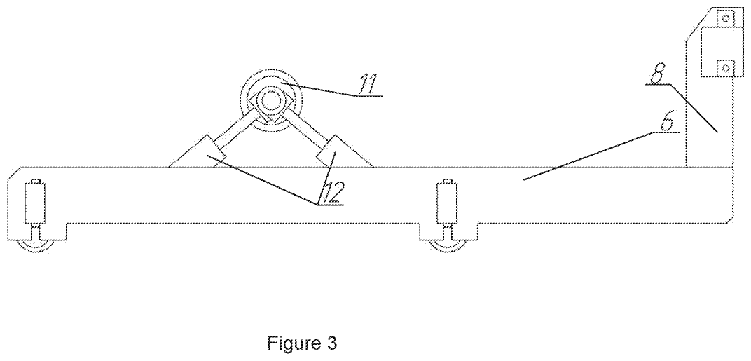

FIG. 3—general view of the welding carriage (side view);

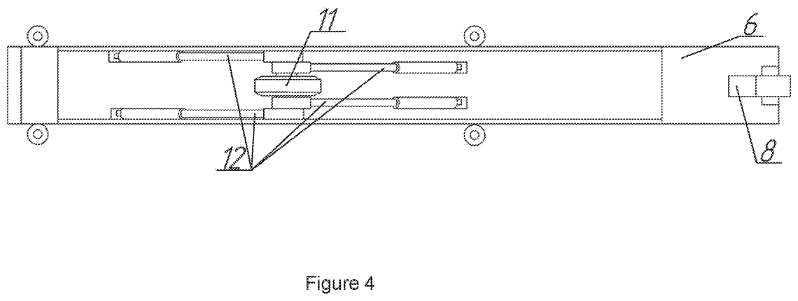

FIG. 4—general view of the welding carriage (top view).

The assembly and welding mill comprises an installed device 1 for feeding a tubular billet 2 with a roller table 3, a welding and assembly stand 4 with hold-down roller beams 5, a carriage 6, guide knives 7, 8, process bridges 9 with welding power sources and welding materials located thereon (no item number). On the assembly and welding stand 4 there is also a laser-arc hybrid welding head 10 with a system of adjusters enabling vertical, horizontal and angular movement.

The carriage 6 is equipped with a thrust roller 11 and mechanisms 12 for adjustment of the height of the hold-down roller and the welding head 10. Such mechanisms will be made as hydraulic cylinders (not shown in the drawing).

The welding carriage is equipped with standard equipment to identify the cut and to point the welding head to the joint of tubular billet edges (not shown in the drawing).

A mill control station 13 is located next to the stand 4.

Before feeding tubular billets for root weld application, the assembly and welding stand 4 is adjusted by movement of hold-down roller beams 5, the thrust roller 11 gets raised/lowered using mechanisms 12, the welding head 10 gets raised/lowered using a system of adjusters, and welding modes are set at the control console 13. Then, the formed tubular billet 2 is supplied to the mill, where it gets positioned with the knife 7 by opening the edges at 12 o'clock position; if required, the knife 7 opens the edges further for passing of the knife 8. The tubular billet is moved by the pipe feed device 1 into welding area, while the carriage is introduced in the cavity of the tubular billet, thus making the rollers of the carriage 6 rotate. While being fed to the work area, the tubular billet gets reduced with the roller beams 5. The vertical roller beam connected to the hydraulic mechanism aligns the edges of the tubular billet relative to each other by applying force on the outer side, while the thrust roller 11 aligns the edges on the inner side. Other roller beams reduce the tubular billet to bring the edges together, then the tubular billet stops to point the welding head 10 to the joint of the edges.

The welding laser head or the hybrid laser-arc welding head is mounted on the supporting elements of the assembly and welding stand using a system of adjustment devices based on typical servo-drives.

Using a system of adjustment devices, the welding head is set up directly in the middle of cut. An operator at the control console 13 checks and, if required, adjusts welding modes.

Thus, according to required process parameters, the welding head applies a continuous root weld on the outer side of the tubular billet (regardless of size) to preliminarily aligned edges.

1. The proposed assembly and welding mill for production of pipes includes a tubular billet feed device with a roller table having a longitudinal axis and passing through the assembly and welding stand with radial hold-down roller beams intended for reduction of a tubular billet that travels along the roller table, as well as a longitudinally oriented guide knife, and a carriage with rollers enabling rotation of the rollers on the inner surface of the tubular billet being moved through the assembly and welding stand, while on the supporting elements of the assembly and welding stand there is a laser welding head or a laser-arc hybrid welding head that can travel in transverse and vertical directions and around the longitudinal axis; the carriage is rigidly connected with the supporting elements of the assembly and welding stand through a vertically oriented and longitudinally directed connecting knife; the guide knife is intended for tubular billet positioning through opening of edges at 12 o'clock position and is mounted on the supporting elements of the assembly and welding stand configured to enable vertical travel and fixation; on the carriage, there is a hold-down roller facing upwards that can travel in vertical direction to act on the edges of tubular billet from the inner side, while one of the roller beams is installed vertically and can act on the tubular billet edges from the outer side.
